(19) United States
(12) Patent Application Publication
(10) Pub. No.: US 2013/0247055 A1
(43) Pub. Date: Sep. 19, 2013

(54) Automatic Execution of Actionable Tasks

(71) Applicants: Mikael Berner, Los Altos, CA (US); Edgar Kalns, San Jose, CA (US); Kesava Neeli, San Jose, CA (US); Guntis Strazds, Riga (LV); Shuhao Zhang, La Prairie (CA)

(72) Inventors: Mikael Berner, Los Altos, CA (US); Edgar Kalns, San Jose, CA (US); Kesava Neeli, San Jose, CA (US); Guntis Strazds, Riga (LV); Shuhao Zhang, La Prairie (CA)

(21) Appl. No.: 13/423,102

(22) Filed: Mar. 16, 2012

(51) Int. Cl. G06F 9/46; G06F 15/173

(52) U.S. Cl. 718/102

(57) ABSTRACT

Provided is a method for automatic execution of actionable tasks, which facilitates the creation of a platform for one-point management of multiple activities and events by enabling automatic performance of various tasks associated with sending wishes and gifts, travel check-ins, travel planning, banking, dining out, making reservations, and other activities. The method may utilize data associated with events or activities from one or more input sources. The method may include identifying one or more actionable tasks, creating one or more automatically executable tasks based on the one or more actionable tasks, executing the created automatically executable actionable tasks, and presenting the results to the user.

### FIELD

This application relates generally to data processing, and, more specifically, to computer-implemented systems and methods for automatic execution of actionable tasks.

### BACKGROUND

Creating and managing tasks can help individuals or groups achieve goals. Task management software tools abound in the marketplace. Project management and calendaring software also often provide task management software with support for task management activities. Task, project management, and calendaring software may allow users to manage their activities by creating and managing to-do lists. Many software solutions are well-known web-based applications, organized for different industry sectors, such as financial services or the travel industry.

However, most of the existing solutions are limited to a single industry sector. Furthermore, these solutions demand affirmative user actions and have very limited functionality with regards to the number and types of input sources they can use.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for automatic execution of actionable tasks, which may be used to create a platform for one-point management of multiple activities of a user by enabling automatic performance of varied tasks associated with sending wishes and gifts, travel check-ins, travel planning, banking, dining out, making reservations, and so forth. The system for execution of actionable tasks (also referred to herein as the system) may reduce significantly, if not eliminate completely, the need for the user to visit multiple applications and/or websites to perform each task individually.

In various exemplary embodiments, monitoring one or more input sources associated with the user to identify the one or more actionable tasks may be performed. The one or more actionable tasks that have been identified may be analyzed to create one or more automatically executable tasks that may be executed based on predetermined execution criteria. In various exemplary embodiments, one or more automatically executable tasks that can be executed without further user involvement may also be identified.

The one or more automatically executable tasks that can be executed without further user involvement may be executed based on predetermined execution criteria or user preferences. The method for automatic execution of actionable tasks may comprise receiving a user request to execute the one or more automatically executable tasks and executing the one or more executable tasks based on the predetermined criteria or preferences.

In further examples, the above steps of the method proposed herein are stored on a machine-readable medium including instructions, which, when implemented by one or more processors, perform the steps. In yet further examples, subsystems or devices can be adapted to perform the recited steps. Other features, examples, and embodiments are described below.

### BRIEF DESCRIPTION OF DRAWINGS

Exemplary embodiments are illustrated by way of example and not limitation in the figures of the accompanying drawings, in which like references indicate similar elements and in which:

FIG. 1 illustrates an exemplary network environment for implementing various aspects of methods and systems for automatic execution of actionable tasks.

FIG. 2 is a block diagram illustrating the process of creating and executing automatically executable tasks.

FIG. 3 is a process flow diagram illustrating the process of creating and executing the one or more automatically executable tasks.

FIG. 4 is a more detailed process flow diagram illustrating the process of creating and executing the one or more automatically executable tasks.

FIG. 5 is a block diagram illustrating some of the steps of a method for automatic execution of actionable tasks, including tools and techniques that may be applied therewith.

FIG. 6 a diagrammatic representation of an exemplary machine in the form of a computer system within which a set of instructions for causing the machine to perform any one or more of the methodologies discussed herein is executed.

### DETAILED DESCRIPTION

Exemplary methods and systems for automatic execution of actionable tasks are described. For the purpose of explanation, the following description contains numerous specific details. These details are set forth in order to ensure a thorough understanding of the exemplary embodiments. It will be evident, however, to one skilled in the art that the present invention may be practiced without these specific details. While some of the concepts are described in conjunction with specific embodiments, it will be understood that these embodiments are not intended to be limiting.

In accordance with various embodiments, one or more actionable tasks may be created based on data related to a variety of events and/or activities associated with the user and retrieved from a range of sources, including various web-based applications, mobile applications, standalone desktop applications, and various other sources.

Based on the one or more actionable tasks, one or more automatically executable tasks may be automatically created by the system, which may be executed by a user or by another system user on behalf of the user. The system may enable the user to execute the one or more automatically executable tasks with minimum effort and, usually, this may be performed with just one click of a button. The execution of the one or more automatically executable tasks may be performed immediately or scheduled as specified by the user.

The system may be instructed to send a notification concerning the outcome of the automated task, for example, by email. A plurality of automatically executable tasks may be created based on a single actionable task. One or more applications monitored by the system may comprise cloud-based applications, such as, for example, social networks and applications associated with different industry sectors. The one or more applications monitored by the system may also comprise personal information systems such as calendar and e-mail applications.

In various exemplary embodiments, data used for creating the one or more automatically actionable tasks may be retrieved from a profile/account of the user, or from profiles/accounts of users of the one or more applications monitored by the system within the one or more applications monitored by the system.

In various exemplary embodiments, the data used for task creation purposes may be retrieved from user groups that exist in the one or more applications monitored by the system in which the user is a member. The data used for task creation purposes may be retrieved from messages received by the user through one or more internal messaging systems of the one or more applications monitored by the system.

The data used for task creation purposes may be retrieved from messages received by the user through one or more internal mailing systems of the one or more applications monitored by the system. The data used for task creation purposes may be retrieved from updates on the one or more internet-accessible sites of the one or more applications monitored by the system.

An example of a task that may be performed is a user being allowed to send a gift to a recipient as part of the execution of the automatically executable task. For example, the user may be able to send a gift card by providing credit card information and indicating a gift service provider and the amount of a selected gift.

The one or more automatically executable tasks may be created based on the contents of a mobile telephone (a telephone call history) or some other mobile device of the user. For example, the system may be set to create the one or more automatically executable tasks based on the user's contact list or calendar events.

The one or more automatically executable tasks may be presented as associated with one or more properties. The properties may comprise a name of an event, a date, and a name of the one or more input sources. The one or more automatically executable tasks may comprise setting up conferences and meetings. Personalization of the one or more automatically executable tasks may be performed using an address book, a social graph, various settings, and historical preferences of the user.

In various exemplary embodiments, the one or more executable tasks may be presented to the user in the form of a to-do list with selectable options and execution buttons associated with the selectable options. To execute the automatically executable task, the user may need to select the check box associated with the automatically executable task and click the corresponding execution button. The one or more automatically executable tasks may be executed by the system based on the predetermined execution criteria and without a user action. The above predetermined execution criteria may be created by the user for a category or type of inputs and/or for the one or more specific input sources.

In various exemplary embodiments, the system may inform the user about the results of the task execution. In various exemplary embodiments, the system may be set to analyze similar events and activities associated with the user that have taken place previously and to use this information in creating the one or more automatically executable tasks. For example, information concerning previous air travel itineraries of the user may be stored in the system and analyzed when the user repeatedly selects one of the stored air travel itineraries. The one or more automatically executable tasks related to the selected air travel itinerary may be created. For example, if the system discovers that on a previous trip the user had a stopover lasting several hours in between scheduled events, such as, for example, several free hours during a flight transfer, the system may suggest other automatically executable tasks based on knowledge of the user's to-do's, the user's current location, and the user's preferences.

In various exemplary embodiments, the user may be able to flexibly define preferences in accordance with which the one or more input sources (for example, a mobile device or a social network), categories of the actionable tasks (for example, flight or travel related events or activities, or a recreational activity), and types of the actionable tasks (for example, a visit to a local restaurant) will be selected. In this or other embodiments, the sources and types of the actionable tasks may be defined by the system by default based on the user-related information available within the system, or suggested by the system and displayed to the user for approval. In further exemplary embodiments, information collected by the system based on the user preferences may be presented to the user dynamically, combined with real-time data (for example, with newly available flight data). Information on the user preferences may be collected by the system interactively (for example, in the form of selectable options (questions and answers)).

In various exemplary embodiments, the system may comprise a dynamically updated calendar to include all the events that can be used to create executable tasks. In other embodiments, the similar calendar of an external system may be used for the same purpose. The system may employ techniques (in particular, techniques associated with Artificial Intelligence (AI) technologies) that would allow the system to submit (simply provide or type in) user-related information to remote servers, such as, for example, to flight booking websites. The one or more actionable tasks may be retrieved from the calendar that is part of a software application or is a standalone application.

Information associated with the one or more automatically executable tasks may be exported to an external software application (for example, to a mobile application) and displayed at a specified date and time. In the same or other embodiments, the automatically executable tasks to be exported to the external application may be pre-selected by the user, both individually or as a type or category. For example, the user may be able to notify the connections of the user in the one or more social networks about an upcoming trip that has been scheduled using the system.

The one or more automatically executable tasks may be exported to the external application based on the calendar or an event-related schedule. The one or more automatically executable tasks may be presented to the user sequentially, based on the event-related schedule or calendar. The event-related schedule may be updated dynamically by the system.

In various exemplary embodiments, one user may be a representative of a group of users of the system, thus being entitled to make decisions on the one or more automatically executable tasks on behalf of several other users. This may be performed by a designated system user with appropriate clearance, also referred to herein as a system monitor (or operator). In various exemplary embodiments, several system monitors with varying authority levels may be supported. A system monitor such as, for example, a travel coordinator, may be able to monitor all information associated with a particular event (for example, a planned trip) provided by multiple designated input sources. This may enable the system monitor to selectively permit members of the supervised group to perform different suggested activities and attend different suggested events.

The system may also be able to compare the inputs from the one or more input sources to avoid duplication in creating the one or more executable tasks. For example, if information concerning a birthday of a person who is connected to the user within a social network group is retrieved from the social network the system may consider the inputs combinable and create a single automatically executable task.

In further exemplary embodiments, the system may group the automatically executable tasks that were created based on the one or more actionable tasks associated with the same activity or event, and present the one or more automatically executable tasks to the user in the form of a single block of information. The system may check the one or more actionable tasks that are based on the information retrieved from the one or more input sources with the one or more automatically executable tasks that have been created previously in order to avoid creating duplicate automatically executable tasks.

The system may check the time data related to the one or more actionable tasks, or the time data related to the one or more automatically executable tasks (i.e., the time and date that the event will take place) against the calendar or event-related schedule of the user. In the event that the time data coincides or overlaps with time data of the one or more automatically executable tasks that have been created previously and executed, the system may inform the user accordingly. This may be done by displaying, within the same block of information, the information on the one or more actionable tasks or automatically executable tasks that have arrived/been generated along with the one or more of the automatically executable tasks that are pending execution or have been executed previously. The user may be allowed to reject the one or more actionable tasks or automatically executable tasks that have arrived/been generated, and/or to cancel the result of the execution of the one or more automatically executable tasks that have previously been executed. In various exemplary embodiments, the user may also be allowed to cancel the one or more automatically executable tasks pending execution if the time data of such tasks coincides or overlaps with the time data of the one or more actionable tasks or one or more automatically executable tasks that have arrived/been generated. In the latter two cases, the calendar and/or event-related schedule of the user may be adjusted accordingly.

In the same or other exemplary embodiments, cancellation of the one or more executed automatically executable tasks may be performed using predefined options. For example, one of the predefined options may be to send an email requesting cancellation of a hotel reservation. In various exemplary embodiments, the system may automatically locate the one or more automatically executable tasks that have been executed, or automatically executable tasks pending execution and associated with the one or more automatically executable tasks that have been cancelled, thereby enabling the user to review or cancel the tasks.

In various exemplary embodiments, the user interface may be associated with a mobile application.

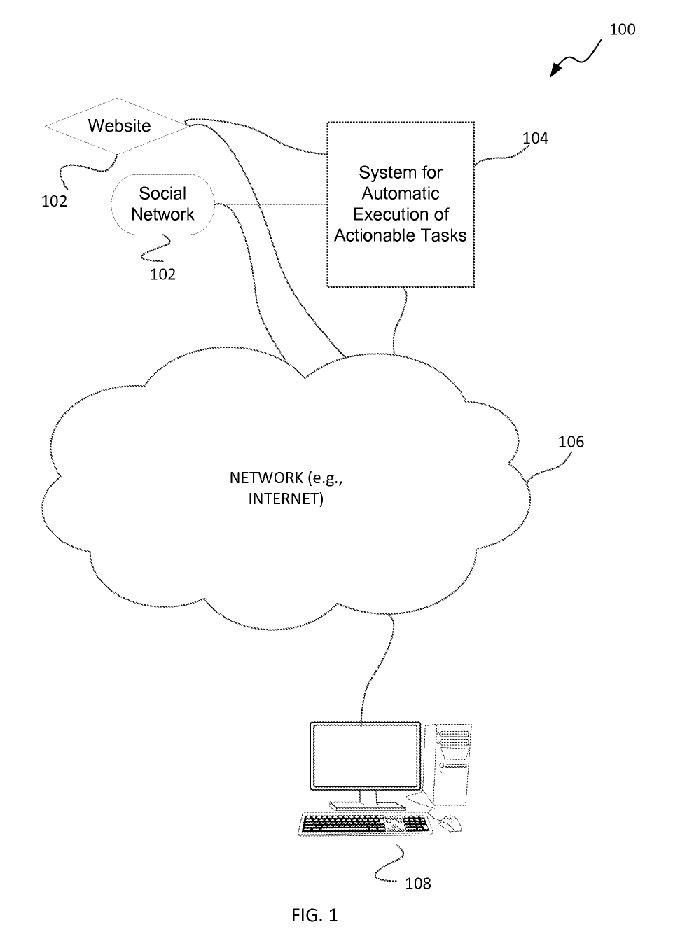

Referring now to the drawings, FIG. 1 illustrates an exemplary network segment 100 for implementing various aspects of methods and systems for automatic execution of actionable tasks, in accordance with various exemplary embodiments. A computer system of the user 108 may be connected to the system for automatic execution of actionable tasks 104 (being, incidentally, a web-based application) via the network 106 (the Internet in this embodiment). The system for automatic execution of actionable tasks 104 may be connected via the network 106 to the multiple input sources 102, which, in the present embodiment, include the website and the social network, for monitoring the multiple input sources 102, identifying the one or more actionable tasks, and creating the one or more automatically executable tasks. The system for automatic execution of actionable tasks 104 may use the network 106 to connect to the computer system of the user 108 for presenting the one or more automatically executable tasks to the user and receiving the user request to execute the one or more automatically executable tasks.

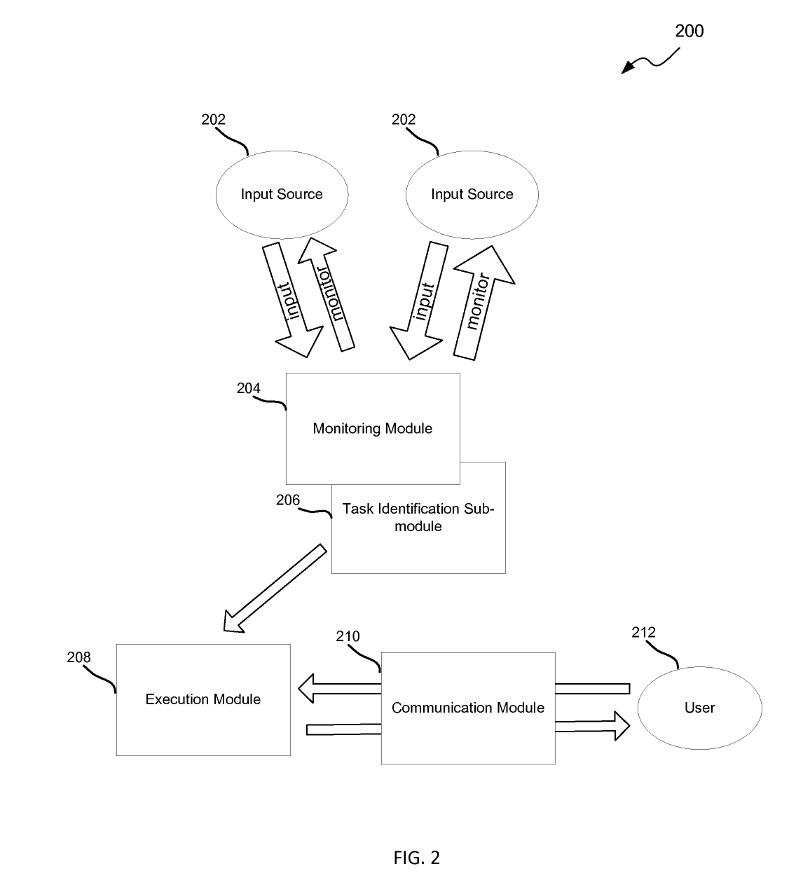

FIG. 2 is a block diagram illustrating the process of the creation and execution of the executable tasks 200. In various embodiments, the monitoring module 204 may monitor the multiple input sources 202, analyzing the events and activities associated with them. The inputs that may be received by the monitoring module 204 from the multiple input sources 202 may be analyzed by the task identification sub-module 206 of the monitoring module 204 to identify the one or more actionable tasks. The information on the one or more identified actionable tasks may be passed on to and executed by execution module 208.

In various exemplary embodiments, the execution module 208 may create the one or more automatically executable tasks based on the one or more actionable tasks that have been identified, and execute the latter automatically based on the predefined execution criteria without a user action. In this and other embodiments, the result of the task execution may be retrieved by the communication module 210 and presented to the user 212.

In other embodiments, the one or more automatically executable tasks may be retrieved from the execution module 208 by the communication module 210 and presented to the user 212, with the user being contemporaneously allowed the option to execute or reject the one or more automatically executable tasks. If the user 212 instructs the execution module 208 to execute the one or more automatically executable tasks (which may be done via the communication module 210), the communication module 210 may retrieve the result of task execution from the execution module 208 and present it to the user 212.

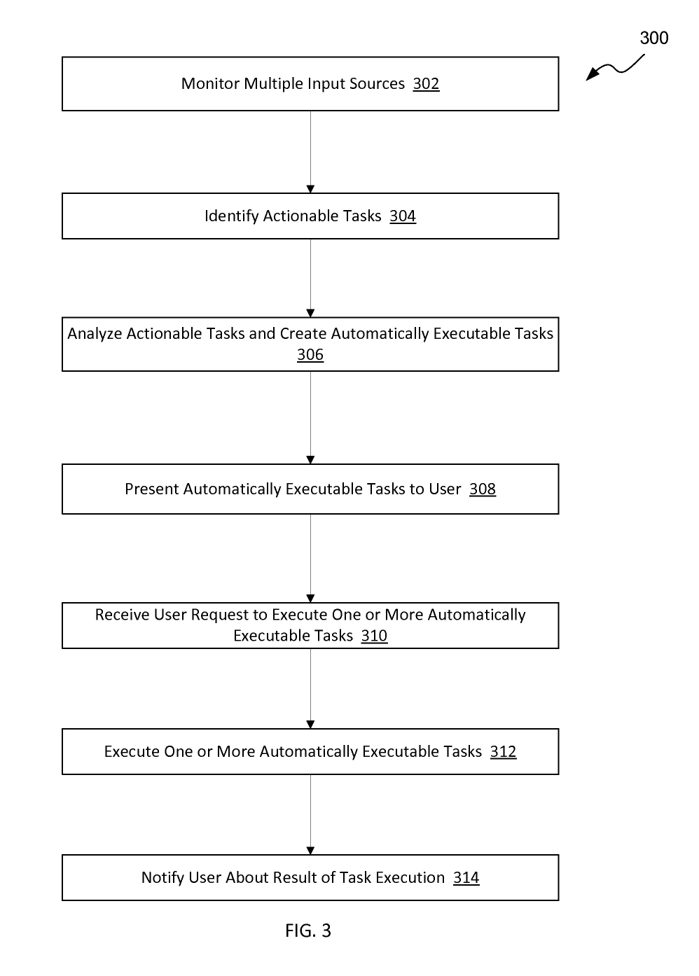

FIG. 3 is a process flow diagram, illustrating a method 300 of creating and executing the one or more automatically executable tasks, in accordance with various embodiments. The method 300 may be performed by processing logic that comprises hardware (e.g., dedicated logic, programmable logic, microcode, etc.), software (such as that which is run on a general-purpose computer system or a dedicated machine), or a combination of both. In one exemplary embodiment, the processing logic resides at the system 200 illustrated in FIG. 2.

The method 300 may commence at operation 302 with the monitoring module 204 monitoring and analyzing the one or more input sources 202. The method may continue at operation 304, wherein the task identification sub-module 206 of the monitoring module 204 may identify the one or more actionable tasks based on the events and activities associated with the inputs that were received from the one or more input sources 202. At operation 306, the analysis and execution module 208 may create the one or more automatically executable tasks based on the one or more actionable tasks that were identified by the task identification sub-module 206. The one or more automatically executable tasks that have been created may be further be presented to the user at operation 308. To be able to execute the one or more automatically executable tasks, the system may receive a request of the user to execute the one or more automatically executable tasks at operation 310. When the user's request to execute the one or more automatically executable tasks is received, the one or more automatically executable tasks may be executed at operation 312, and the user may be notified about the result of task execution at operation 314.

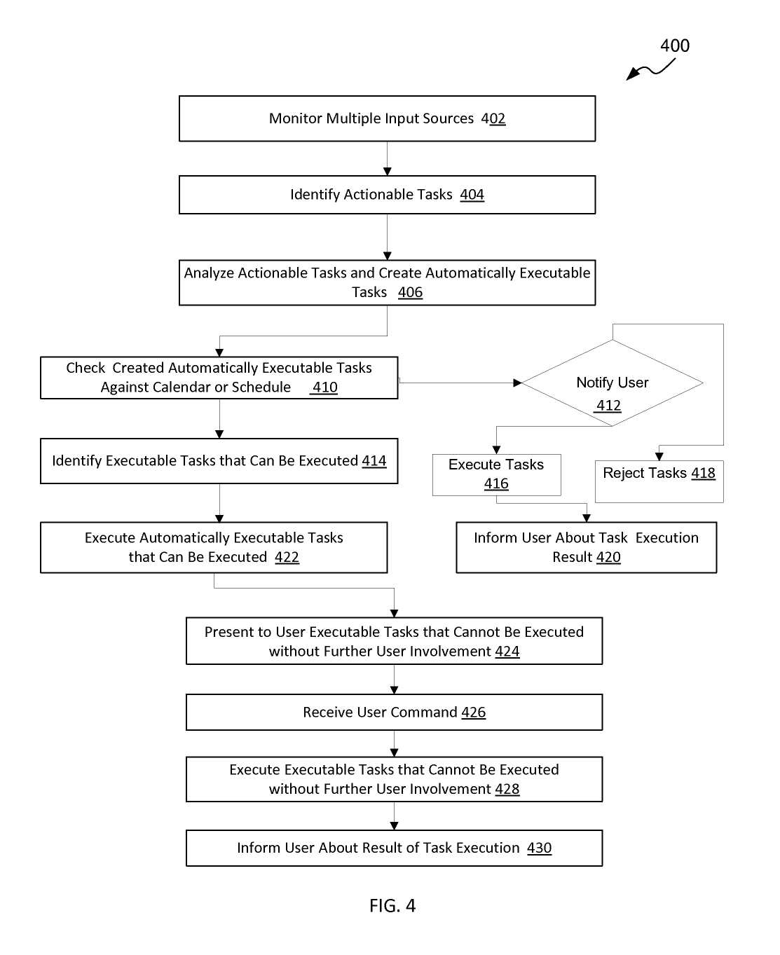

FIG. 4 is a more detailed process flow diagram, illustrating a method 400 for automatic execution of actionable tasks, in accordance with various embodiments. The method 400 may be performed by processing logic that may comprise hardware (e.g., dedicated logic, programmable logic, microcode, etc.), software (such as that which is run on a general-purpose computer system or a dedicated machine), or a combination of both. In one exemplary embodiment, the processing logic resides at the system 200 illustrated in FIG. 2.

The method 400 may commence at operation 402 with the monitoring module 204 monitoring and analyzing the one or more input sources 202, and continues at operation 404, wherein the task identification sub-module 206 of the monitoring module 204 may identify the one or more actionable tasks based on the events and activities associated with the inputs received from the multiple input sources 202. At operation 406, the execution module 208 may create the one or more automatically executable tasks based on the one or more actionable tasks that were identified by the task identification sub-module 206 of the monitoring module 204. The method may proceed at operation 410 with checking the one or more automatically executable tasks that have been created against the calendar and/or event or activity-related schedule of the user and notifying the user at operation 412 if the one or more identical previously executed automatically executable tasks, or automatically executable tasks pending execution, have been discovered. In the latter case, depending on the decision on the user on whether the one or more automatically executable tasks that have been presented should be executed, the method may continue with executing the one or more automatically executable tasks at operation 416, or with the user rejecting the one or more automatically executable tasks at operation 418. At operation 420, the communication module 210 may inform the user about the result of the task execution.

At operation 414, the one or more automatically executable tasks that can be executed without further user involvement based on the predetermined execution criteria may be identified, and then executed without a further user action by the execution module 208 at operation 422.

At operation 424, the one or more automatically executable tasks that cannot be executed without further user involvement may be presented to the user by the communication module 210, which may provide an executable control via a user interface. Communication module 210 may receive the request of the user to execute the one or more automatically executable tasks that cannot be executed without further user involvement at operation 426. The method may proceed with the execution module 208 executing the one or more of the automatically executable tasks at operation 428, and end at operation 430, with the communication module 210 informing the user about the result of task execution.

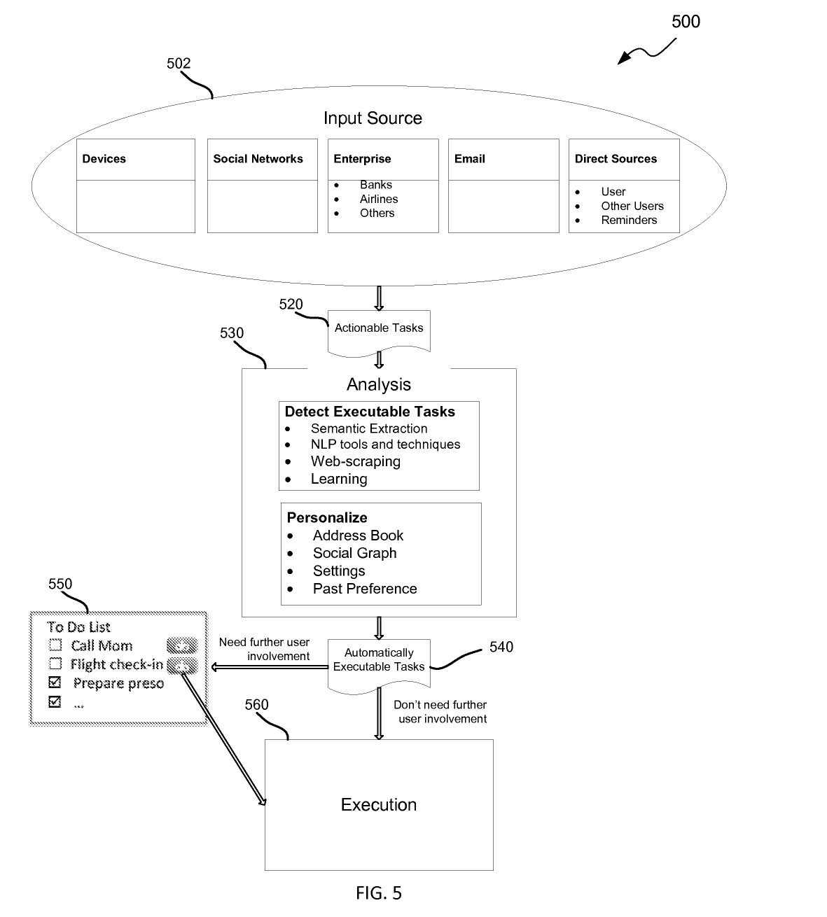

FIG. 5 is a block diagram illustrating some of the steps of a method 500 for automatic execution of actionable tasks and the tools and techniques that may be applied therewith, in accordance with various embodiments. The multiple input sources 510 may include different devices, social networks, enterprise input sources (such as, for example, banks and airlines, email applications, and direct input from various sources, including the user), other system users, and reminders.

The one or more actionable tasks 520 may be identified, retrieved from the one or more input sources 510, subjected to analysis, and processed at step 530. The identification of the one or more actionable tasks may be performed using a plurality of tools and techniques, for example, the tools and techniques associated with semantic extraction and NLP. The identification of the one or more actionable tasks may also be done using Web scraping tools and techniques, learning tools and techniques, and execution tools and techniques. The step 530 may also comprise creating the one or more automatically executable tasks based on the one or more actionable tasks.

Personalization of the one or more automatically executable tasks that have been created may be performed using multiple sources, such as, for example, the address book, social graph, settings, and past preferences of the user.

The one or more of the automatically executable tasks 540 that can be executed without further user involvement may be automatically executed by the system without a user action at step 560. The one or more of the automatically executable tasks 540 that cannot be executed without further user involvement may be displayed or otherwise presented to the user at step 550 in the form of a to-do list with selectable options and execution buttons associated with the selectable options. To instruct the system to execute the one or more automatically executable tasks 540, the user may select one or more corresponding check boxes, and click one or more corresponding execution (or “to do”) buttons. The one or more automatically executable tasks 540 may then be executed.

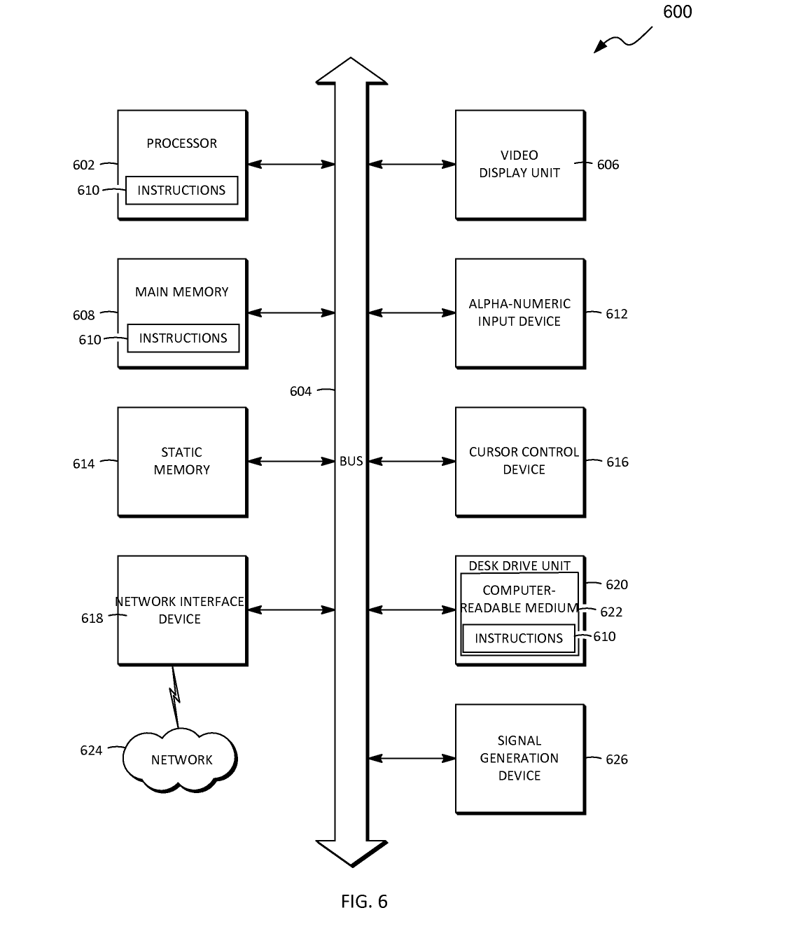

FIG. 6 is a diagrammatic representation of an exemplary machine in the form of a computer system 600, within which a set of instructions for causing the machine to perform any one or more of the methodologies discussed herein may be executed. In various exemplary embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes the network 624, a processor or multiple processors 602 (e.g., a central processing unit (CPU), a graphics processing unit (GPU), or both), and a main memory 608 and static memory 614, which communicate with each other via a bus 604. The computer system 600 may further include a video display unit 606 (e.g., a liquid crystal display (LCD)). The computer system 600 may also include an alphanumeric input device 612 (e.g., a keyboard), a cursor control device 616 (e.g., a mouse), a voice recognition or biometric verification unit, a disk drive unit 620, a signal generation device 626 (e.g., a speaker), and a network interface device 618. The computer system 600 may further include a data encryption module (not shown) to encrypt data.

The disk drive unit 620 includes a computer-readable medium 622 on which one or more sets of instructions and data structures are stored (e.g., instructions 610), embodying or utilizing any one or more of the methodologies or functions described herein. The instructions 610 may also reside, completely or at least partially, within the main memory 608 or within the processors 602 during execution thereof by the computer system 600. The main memory 608 and the processors 602 may also constitute machine-readable media.

The instructions 610 may further be transmitted or received over a network 624 via the network interface device 618 utilizing any one of a number of the well-known transfer protocols (e.g., Hyper Text Transfer Protocol (HTTP)).

While the computer-readable medium 622 is shown in an exemplary embodiment to be a single medium, the term “computer-readable medium” should be taken to include a single medium or multiple media (e.g., a centralized or distributed database or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The exemplary embodiments described herein may be implemented in an operating environment comprising software installed on a computer, in hardware, or in a combination of software and hardware.

Although the embodiments have been described with reference to specific exemplary embodiments, it will be evident that various modifications and changes may be made to these embodiments without departing from the broader spirit and scope of the system and method described herein. Accordingly, the specification and drawings are to be regarded in an illustrative rather than a restrictive sense.

1. A computer-implemented method, executable by a processor, for automatic execution of actionable tasks of a user, the method comprising:
monitoring one or more input sources associated with the user to identify one or more actionable tasks;
identifying the one or more actionable tasks;
analyzing the one or more actionable tasks to create one or more automatically executable tasks based on predetermined execution criteria;
identifying the one or more automatically executable tasks that can be executed without further user involvement and executing them based on the predetermined execution criteria;
providing an executable control via a user interface to receive a user request to execute the one or more automatically executable tasks;
receiving, via the user interface, the user request to execute the one or more automatically executable tasks; and
selectively executing the one or more automatically executable tasks.

2. The computer-implemented method of claim 1, wherein the one or more input sources include one or more of the following: a social network, a calendar, an email system, a blog, a website, a contact list, a telephone call history, and an SMS history.

3. The computer-implemented method of claim 1, wherein the monitoring of the one or more input sources includes analyzing activities and events associated with the input sources.

4. The computer-implemented method of claim 1, wherein the executable control is displayed within a context of the one or more input sources associated with the one or more actionable tasks.

5. The computer-implemented method of claim 1, wherein the user interface is associated with a mobile application.

6. The computer-implemented method of claim 1, wherein the one or more automatically executable tasks are presented with one or more of the following properties: a name of an event, a date, and a name of the one or more input sources.

7. The computer-implemented method of claim 1, wherein the identification of the one or more actionable tasks is based on information associated with an account of the user or a group of users to which the user belongs.

8. The computer-implemented method of claim 1, wherein the executable control includes one or more predetermined options.

9. The computer-implemented method of claim 1, wherein the user indicates a delay to precede the execution of the one or more automatically executable tasks.

10. The computer-implemented method of claim 1, wherein the execution of the one or more automatically executable tasks includes one or more of the following: sending a gift, an email, an SMS, setting up a conference.

11. A system for automatic execution of actionable tasks of a user, the system comprising:
a monitoring module executable by a processor and configured to monitor one or more input sources associated with the user, analyze activities and events associated with the input sources, and receive inputs from the one or more input sources;
a communication module executable by a processor and configured to receive the user request to execute one or more automatically executable tasks, receive from the analysis and execution module a task execution result, and present the result to the user;
an analysis and task creation module executable by a processor and configured to analyze the one or more actionable tasks and create one or more automatically executable tasks based on predetermined execution criteria; and
an execution module executable by a processor and configured to execute the one or more automatically executable tasks.

12. The computer system of claim 11, wherein the monitoring module is further configured to monitor one or more of the following: a social network, a calendar, an email system, a blog, a website, a contact list, a telephone call history, and an SMS history.

13. The computer system of claim 11, wherein the communication module is further configured to receive inputs from one or more of the following: a social network, a calendar, an email system, a blog, a website, a contact list, a telephone call history, and an SMS history.

14. The computer system of claim 11, wherein the analysis and task creation module is further configured to create the one or more actionable tasks based on data retrieved from one or more of the following: a social network, a calendar, an email system, a blog, a website, a contact list, a telephone call history, and an SMS history.

15. The computer system of claim 11, wherein the analysis and task creation module is further configured to present to the user the created automatically executable tasks while contemporaneously displaying an executable control that enables executing the displayed automatically executable tasks.

16. The computer system of claim 11, wherein presenting the created automatically executable tasks to the user further comprises presenting the one or more of the following related properties: a name of an event, a date, and a name of the one or more input sources.

17. The computer system of claim 11, wherein the execution module is further configured to automatically execute, without user action and based on the predetermined execution criteria, the created automatically executable tasks identified as automatically executable tasks whose execution can be performed without further user involvement.

18. The computer system of claim 11, wherein the task creation module is further configured to distinguish the automatically executable tasks, the execution of which can be performed based on the predetermined execution criteria without further user involvement.

19. The computer system of claim 11, wherein the monitoring module further comprises a task identification sub-module module, configured to identify the one or more actionable tasks.

20. A non-transitory computer-readable medium having instructions stored thereon, which when executed by one or more computers, causes the one or more computers to:
monitor one or more input sources associated with a user to identify one or more actionable tasks;
identify the one or more actionable tasks;
analyze the one or more actionable tasks to create one or more automatically executable tasks based on predetermined execution criteria;
distinguish one or more automatically executable tasks that can be executed without further user involvement and execute them based on predetermined criteria;
provide an executable control via a user interface to receive a user request to execute the one or more automatically executable tasks;
receive, via the user interface, the user request to execute the one or more automatically executable tasks;
selectively execute the one or more automatically executable tasks.
